(19) United States
(12) Patent Application Publication
(10) Pub. No.: US 2025/0114883 A1
(43) Pub. Date: Apr. 10, 2025

(54) PRE-WELDING POSITIONING SYSTEM AND METHOD

(71) Applicant: CONTEMPORARY AMPEREX TECHNOLOGY (HONG KONG) LIMITED, Hong Kong (CN)

(72) Inventors: Kai WU, Ningde (CN); Beining ZHANG, Ningde (CN); Ying WU, Ningde (CN); Wenchong WANG, Ningde (CN); Jun ZHAO, Ningde (CN); Wenjie XIE, Ningde (CN)

(21) Appl. No.: 18/949,725

(22) Filed: Nov. 15, 2024

Related U.S. Application Data
(63) Continuation of application No. PCT/CN2023/139609, filed on Dec. 18, 2023.

(30) Foreign Application Priority Data
Oct. 8, 2023 (CN) 202311289967.1

(51) Int. Cl. B23K 37/04; B23K 101/36

(52) U.S. Cl. CPC B23K 37/0452; B23K 2101/36

(57) ABSTRACT

A pre-welding positioning system includes a frame body, a controller, a three-axis mechanism arranged on the frame body, and a vision acquisition system and a fixing component arranged on the three-axis mechanism. The controller is configured to control the three-axis mechanism to move to a designated position based on product information of a battery pack to be welded. The vision acquisition system is configured to acquire, at the designated position, an image of a positioning component of the battery pack, in response to the three-axis mechanism reaching the designated position, and determine a distance deviation value between the positioning component and a preset reference point based on the acquired detection image. The controller is further configured to control the three-axis mechanism to drive the fixing component to the positioning component based on the distance deviation value to fix the battery pack to the frame body by the fixing component.

### CROSS-REFERENCE TO RELATED APPLICATIONS

The present application is a continuation of International Application No. PCT/CN2023/139609, filed on Dec. 18, 2023, which claims priority to Chinese Patent Application No. 202311289967.1 filed on Oct. 8, 2023 and entitled “PRE-WELDING POSITIONING SYSTEM AND METHOD”, the entire contents of both of which are incorporated herein by reference.

### TECHNICAL FIELD

The present disclosure relates to the technical field of pre-welding positioning of battery packs, and in particular to a pre-welding positioning system and method.

### BACKGROUND ART

New energy batteries are becoming widely used in life and industry. For example, new energy vehicles equipped with the batteries have been widely used. In addition, the batteries are increasingly used in energy storage and other fields.

In the related technologies, it is needed for a battery pack to have a corresponding welding positioning hole thereof accurately identified before the battery pack enters a station for welding. An inaccurate identification of the welding positioning hole may result in a low yield or a low efficiency in subsequent welding.

### SUMMARY

The present disclosure provides a pre-welding positioning system and method, aiming to improving the pre-welding positioning accuracy of battery packs.

The present disclosure provides a pre-welding positioning system, including: a frame body, a controller, a three-axis mechanism arranged on the frame body, and a vision acquisition system and a fixing component arranged on the three-axis mechanism, where
the controller is configured to control the three-axis mechanism to move to a designated position based on product information of a battery pack to be welded;
the vision acquisition system is configured to acquire, at the designated position, an image of a positioning component of the battery pack, in response to the three-axis mechanism reaching the designated position; and determine a distance deviation value between the positioning component and a preset reference point based on the acquired detection image; and
the controller is further configured to control the three-axis mechanism to drive the fixing component to the positioning component based on the distance deviation value so as to fix the battery pack to the frame body by the fixing component.

As such, the vision acquisition system arranged on the three-axis mechanism acquires, at the designated position, the image of the positioning component of the battery pack, in response to the controller controlling the three-axis mechanism to reach the designated position, and obtains the distance deviation value between the positioning component and the preset reference point, such that the controller controls the three-axis mechanism to drive the fixing component to the positioning component based on the distance deviation value so as to fix the battery pack to the frame body by the fixing component. In this way, the battery pack can be accurately positioned in the pre-welding positioning system, thereby improving the accuracy and efficiency of the battery pack in the welding process.

In some embodiments of the present disclosure, the frame body is further provided with a jacking mechanism on which a jacking cylinder is arranged, and the jacking cylinder extends to disengage the battery pack on a transport trolley from the transport trolley; and the controller is further configured to control the jacking cylinder to extend to jack up the battery pack to a preset height, in response to a positioning request sent by the transport trolley; and then control the three-axis mechanism to move to the designated position based on the product information.

As such, the battery pack on the transport trolley is jacked up by the jacking mechanism having the jacking cylinder and arranged on the frame body, such that the battery pack is disengaged from the transport trolley, thereby providing a foundation for subsequent pre-welding positioning of the battery pack.

In some embodiments of the present disclosure, the controller is further configured to obtain the read product information of the battery pack and information to be compared of the battery pack, in response to the positioning request sent by the transport trolley; and control the jacking cylinder to extend in response to the product information being consistent with the information to be compared.

As such, the controller can compare the product information of the battery pack on the transport trolley to the pre-stored information to be compared in the pre-welding positioning system, which can reduce the probability that the battery pack entering the pre-welding positioning system does not meet the expectation, thereby providing a foundation for subsequent accurate pre-welding positioning of the battery pack by means of the foolproof measures.

In some embodiments of the present disclosure, the vision acquisition system is further configured to send the distance deviation value to a storage module of the controller; and the distance deviation value includes: a first deviation value in an X-axis direction and a second deviation value in a Y-axis direction in a two-dimensional plane coordinate system.

As such, the vision acquisition system is configured to send the obtained distance deviation value to the storage module of the controller, so that the controller can subsequently perform data storage and security management of the distance deviation value.

In some embodiments of the present disclosure, the controller is further configured to control an X-axis movement mechanism and a Y-axis movement mechanism on the three-axis mechanism to move based respectively on the first deviation value and the second deviation value, such that the fixing component moves to a position directly above the positioning component; and the controller is further configured to control a Z-axis movement mechanism on the three-axis mechanism to descend to the preset height, in response to the fixing component reaching the position directly above the positioning component, such that the fixing component is inserted into the positioning component.

As such, the controller is further configured to control the X-axis movement mechanism and the Y-axis movement mechanism on the three-axis mechanism to move to the position directly above the positioning component and control the Z-axis movement mechanism on the three-axis mechanism to descend to the preset height based respectively on the first deviation value, the second deviation value, and the battery pack jacked up to the preset height, such that the fixing component arranged on the three-axis mechanism is automatically inserted into the positioning component of the battery pack. In this way, the fixing component is inserted into the positioning component accurately through multi-dimensional adjustment.

In some embodiments of the present disclosure, the controller is further configured to determine a first compensated distance value corresponding to the X-axis movement mechanism based on the first deviation value and determine a second compensated distance value corresponding to the Y-axis movement mechanism based on the second deviation value; and the controller is further configured to control the X-axis movement mechanism to move based on the first compensated distance value and control the Y-axis movement mechanism to move based on the second compensated distance value, such that the fixing component moves to the position directly above the positioning component.

As such, the controller is configured to control the X-axis movement mechanism to move based on the first compensated distance value corresponding to the first deviation value and control the Y-axis movement mechanism to move based on the second compensated distance value corresponding to the second deviation value, respectively. In this way, the fixing component on the three-axis mechanism can be controlled to be accurately positioned directly above the positioning component.

In some embodiments of the present disclosure, a lower frame body and an upper frame body are provided on the frame body, the jacking mechanism is arranged on the lower frame body, a truss is arranged on the upper frame body, and two three-axis mechanisms are arranged on the truss; and the transport trolley transports the battery pack in a preset direction into a preset station corresponding to the frame body, and after the battery pack is disengaged from the transport trolley, the transport trolley pulls out of the preset station in a direction opposite to the preset direction; and the two three-axis mechanisms are configured to fix positioning components located on two opposite corners of the battery pack.

As such, the positioning components located on the two opposite corners of the battery pack are respectively fixed by the two three-axis mechanisms, such that the fixation between the battery pack and the frame body is more stable and secure.

The present disclosure provides a pre-welding positioning method, applied to a controller of a pre-welding positioning system, the pre-welding positioning system including: a frame body, a three-axis mechanism arranged on the frame body, and a vision acquisition system and a fixing component arranged on the three-axis mechanism, where
the controller controls the three-axis mechanism to move to a designated position based on product information of a battery pack to be welded, such that the vision acquisition system acquires, at the designated position, an image of a positioning component of the battery pack;
obtains a distance deviation value, between the positioning component and a preset reference point, determined by the vision acquisition system based on the acquired detection image; and
controls the three-axis mechanism to drive the fixing component to the positioning component based on the distance deviation value so as to fix the battery pack to the frame body by the fixing component.

The present disclosure provides another pre-welding positioning method, applied to a pre-welding positioning system, the pre-welding positioning system including: a frame body, a controller, a three-axis mechanism arranged on the frame body, and a vision acquisition system and a fixing component arranged on the three-axis mechanism, where
the controller controls the three-axis mechanism to move to a designated position based on product information of a battery pack to be welded;
the vision acquisition system acquires, at the designated position, an image of a positioning component of the battery pack, in response to the three-axis mechanism reaching the designated position;
the vision acquisition system determines a distance deviation value between the positioning component and a preset reference point based on the acquired detection image; and
the controller controls the three-axis mechanism to drive the fixing component to the positioning component based on the distance deviation value so as to fix the battery pack to the frame body by the fixing component.

The embodiments of the present disclosure provide a pre-welding positioning system and method, the pre-welding positioning system including: a frame body, a controller, a three-axis mechanism arranged on the frame body, and a vision acquisition system and a fixing component arranged on the three-axis mechanism, where the controller is configured to control the three-axis mechanism to move to a designated position based on product information of a battery pack to be welded; the vision acquisition system is configured to acquire, at the designated position, an image of a positioning component of the battery pack, in response to the three-axis mechanism reaching the designated position; and determine a distance deviation value between the positioning component and a preset reference point based on the acquired detection image; and the controller is further configured to control the three-axis mechanism to drive the fixing component to the positioning component based on the distance deviation value so as to fix the battery pack to the frame body by the fixing component. As such, the vision acquisition system arranged on the three-axis mechanism acquires, at the designated position, the image of the positioning component of the battery pack, in response to the controller controlling the three-axis mechanism to reach the designated position, and obtains the distance deviation value between the positioning component and the preset reference point, such that the controller controls the three-axis mechanism to drive the fixing component to the positioning component based on the distance deviation value so as to fix the battery pack to the frame body by the fixing component. In this way, the battery pack can be accurately positioned in the pre-welding positioning system, thereby improving the accuracy and efficiency of the battery pack in the welding process.

The above description is merely an overview of the technical solutions of the present disclosure, which can be carried out according to the contents of the description in order to make technical means of the present disclosure more clearly understood, and in order to make the above and other objects, features, and advantages of the present disclosure more easily understood, specific implementations of the present disclosure are exemplarily described below.

### BRIEF DESCRIPTION OF THE DRAWINGS

In order to illustrate the technical solutions in embodiments of the present disclosure more clearly, the following briefly describes the accompanying drawings for describing the embodiments. Apparently, the accompanying drawings in the following description show merely some embodiments of the present disclosure, and those of ordinary skill in the art may still derive other drawings from the structures shown in the accompanying drawings without creative efforts.

FIG. 1 is a schematic diagram of composition of a frame body in a pre-welding positioning system according to some embodiments of the present disclosure;

FIG. 2 is a schematic diagram of composition of a three-axis mechanism in a frame body according to some embodiments of the present disclosure;

FIG. 3 is a schematic diagram showing an offset between a positioning component in a battery pack and a vision acquisition center of a vision acquisition system according to some embodiments of the present disclosure;

FIG. 4 is a schematic diagram of composition of a jacking mechanism in a frame body according to some embodiments of the present disclosure;

FIG. 5 is a schematic flowchart of a pre-welding positioning method according to some embodiments of the present disclosure; and

FIG. 6 is a schematic flowchart of another pre-welding positioning method according to some embodiments of the present disclosure.

### DESCRIPTION OF REFERENCE SIGNS

1—frame body; 11—three-axis mechanism; 111—X-axis movement mechanism; 112—Y-axis movement mechanism; 113—Z-axis movement mechanism; 114—vision acquisition system; 1141—vision acquisition center; 115—fixing component; 12—jacking mechanism; 121—jacking cylinder; 2—positioning component; A-first direction; B-second direction; C-third direction.

### DETAILED DESCRIPTION OF EMBODIMENTS

The technical solutions in the embodiments of the present disclosure will now be described clearly and fully below with reference to the accompanying drawings in the embodiments of the present disclosure. Apparently, the embodiments described are only some of, rather than all of, the embodiments of the present disclosure. All other embodiments obtained by those of ordinary skill in the art based on the embodiments of the present disclosure without creative efforts shall fall within the protection scope of the present disclosure.

In the description of the embodiments of the present disclosure, the orientation or position relationships indicated by the technical terms “central”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc., are based on the orientation or position relationships shown in the accompanying drawings and are merely intended to facilitate and simplify the description of the embodiments of the present disclosure, rather than indicating or implying that the device or element considered must have a particular orientation or be constructed and operated in a particular orientation, and therefore not to be construed as limiting the embodiments of the present disclosure.

In the description of the embodiments of the present disclosure, unless otherwise explicitly specified and defined, the technical terms such as “mounting”, “connecting”, “coupling”, and “fixing” should be construed in a broad sense, for example, they may be a fixed connection, a detachable connection, or an integration connection; may be a mechanical connection or an electric connection; and may be a direct connection or an indirect connection by means of an intermediate medium, or may be communication between interiors of two elements or interaction between the two elements. For those of ordinary skill in the art, the specific meanings of the above terms in the embodiments of the present disclosure may be construed according to specific circumstances.

In addition, the terms “first”, “second”, etc., as described in the present disclosure, are used for descriptive purposes only and are not to be construed as indicating or implying relative importance or as implicitly indicating the number of technical features indicated. Therefore, the features defined with “first” and “second” may explicitly or implicitly include at least one of the features. In addition, “and/or”, when appearing throughout the text, is intended to include three parallel solutions, such as “A and/or B” which includes a solution A, a solution B, or a solution where both A and B are met. In addition, the technical solutions of various embodiments can be combined with each other, provided that the technical solutions can be implemented by those of ordinary skill in the art. When the combination of technical solutions is contradictory or impossible to implement, it is considered that the combination of the technical solutions does not exist and the combination is not within the protection scope of the present disclosure.

From the perspective of the development of the market situation, traction batteries are becoming widely used, and the types of the traction batteries are increasing. The traction batteries are not only used in energy storage power systems such as hydraulic power, thermal power, wind power, and solar power stations, but also widely used in electric vehicles such as electric bicycles, electric motorcycles, electric vehicles, aerospace, and other fields. With the continuous expansion of the application field of traction batteries, the market demand for the traction batteries is also expanding.

A battery pack is one of the main components of new energy vehicles, and its internal structure is usually a distributed frame structure, and standoffs inside the battery pack need to be welded to internal beams of a housing of the battery pack. In the related technologies, in the welding process of the battery pack, the position of the battery pack is likely to be offset due to vibration in transportation of the battery pack. As a result, in the welding of the battery pack, the mounting accuracy may be reduced due to the position offset of the battery pack, thereby affecting the welding quality and welding efficiency of the entire battery pack.

Based on the above problem, the embodiments of the present disclosure disclose a pre-welding positioning system and method, the pre-welding positioning system including: a frame body, a controller, a three-axis mechanism arranged on the frame body, and a vision acquisition system and a fixing component arranged on the three-axis mechanism, where the controller is configured to control the three-axis mechanism to move to a designated position based on product information of a battery pack to be welded; the vision acquisition system is configured to acquire, at the designated position, an image of a positioning component of the battery pack, in response to the three-axis mechanism reaching the designated position; and determine a distance deviation value between the positioning component and a preset reference point based on the acquired detection image; and the controller is further configured to control the three-axis mechanism to drive the fixing component to the positioning component based on the distance deviation value so as to fix the battery pack to the frame body by the fixing component. As such, the vision acquisition system arranged on the three-axis mechanism acquires, at the designated position, the image of the positioning component of the battery pack, in response to the controller controlling the three-axis mechanism to reach the designated position, and obtains the distance deviation value between the positioning component and the preset reference point, such that the controller controls the three-axis mechanism to drive the fixing component to the positioning component based on the distance deviation value so as to fix the battery pack to the frame body by the fixing component. In this way, the battery pack can be accurately positioned in the pre-welding positioning system, thereby improving the accuracy and efficiency of the battery pack in the welding process.

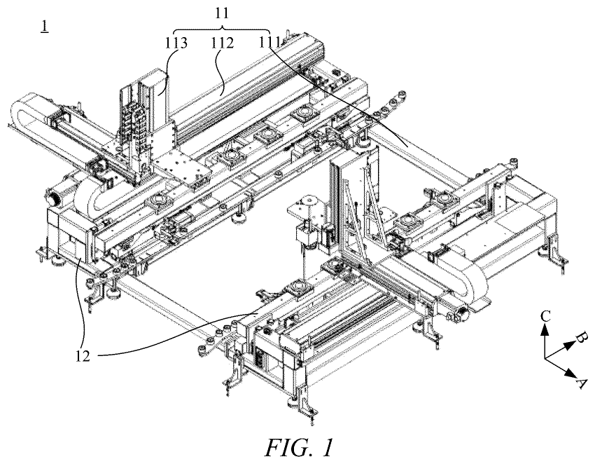

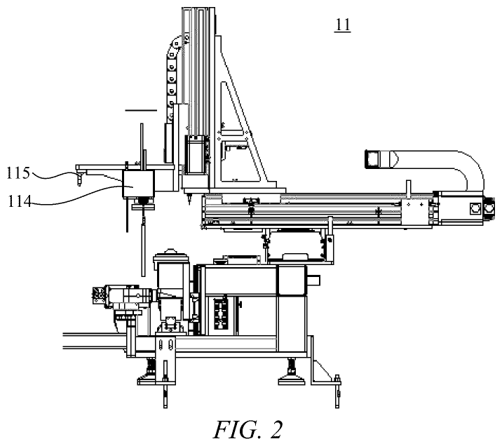

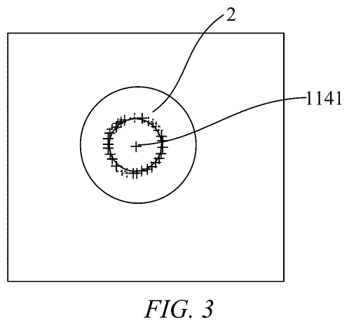

In the following embodiments, for ease of description, a pre-welding positioning system according to an embodiment of the present disclosure will be described as an example. Reference is now made to FIG. 1, FIG. 2, and FIG. 3. FIG. 1 is a schematic diagram of composition of a frame body in a pre-welding positioning system according to some embodiments of the present disclosure, FIG. 2 is a schematic diagram of composition of a three-axis mechanism in a frame body according to some embodiments of the present disclosure, and FIG. 3 is a schematic diagram showing an offset between a positioning component in a battery pack and a vision acquisition center of a vision acquisition system according to some embodiments of the present disclosure. The following description is given in conjunction with FIG. 1 to FIG. 3. The pre-welding positioning system includes: a frame body 1, a controller (not shown), a three-axis mechanism 11 arranged on the frame body 1, and a vision acquisition system 114 and a fixing component 115 arranged on the three-axis mechanism 11.

The controller is configured to control the three-axis mechanism 11 to move to a designated position based on product information of a battery pack to be welded.

The vision acquisition system 114 is configured to acquire, at the designated position, an image of a positioning component 2 of the battery pack, in response to the three-axis mechanism 11 reaching the designated position; and determine a distance deviation value between the positioning component 2 and a preset reference point based on the acquired detection image.

The controller is further configured to control the three-axis mechanism 11 to drive the fixing component 115 to the positioning component 2 based on the distance deviation value so as to fix the battery pack to the frame body 1 by the fixing component 115.

In some embodiments of the present disclosure, the pre-welding positioning system is a system for positioning the battery pack to be welded (not shown). The pre-welding positioning system includes at least: the frame body 1, the controller, the three-axis mechanism 11 arranged on the frame body 1, and the vision acquisition system 114 and the fixing component 115 arranged on the three-axis mechanism 11. The controller may be a programmable logic controller (PLC) herein, and the controller may be configured to exchange information with the vision acquisition system 114 so as to control the vision acquisition system 114 to move to the designated position and perform associated acquisition operations.

Following the preceding description, there may be one three-axis mechanism 11 or two or more three-axis mechanisms 11 arranged on the frame body 1. When there are two or more three-axis mechanisms 11 arranged on the frame body 1, the two or more three-axis mechanisms 11 on the frame body 1 may be specifically disposed, for example, diagonally or in parallel.

In some embodiments of the present disclosure, the three-axis mechanism 11 on the frame body 1 may be a three-axis servo intelligent positioning system, and as shown in FIG. 1, the three-axis mechanism 11 may include: an X-axis movement mechanism 111, a Y-axis movement mechanism 112, and a Z-axis movement mechanism 113, which can control an object to move in a first direction, i.e., in a direction where the X-axis movement mechanism 111 is located, control the object to move in a second direction, i.e., in a direction where the Y-axis movement mechanism is located, and also control the object to move in a third direction, i.e., in a direction where the Z-axis movement mechanism is located, namely, controlling a lifting movement of the object through controlling the Z-axis movement mechanism 113. That is, the three-axis servo intelligent positioning system can spatially position the object in three directions.

The vision acquisition system 114 arranged on the three-axis mechanism 11 is a machine vision system, which may be: a complementary metal oxide semiconductor (CMOS) image sensing system or a charge coupled device (CCD) image sensing system.

As shown in FIG. 2, the relative position relationship between the vision acquisition system 114 and the fixing component 115 arranged on the three-axis mechanism 11 can be set in advance by the pre-welding positioning system. The fixing component 115 may be: a fixing element such as a pin, a bolt, or a nut.

In some embodiments of the present disclosure, the fixing component 115 may be connected to or combined with the positioning component 2 of the battery pack to be welded, such that the battery pack to be welded is fixed to the frame body 1.

In some embodiments of the present disclosure, the battery pack to be welded may be any type of battery pack. The pre-welding positioning system is configured to position the positioning component 2 of the battery pack to be welded, and herein, the battery pack may have one positioning component 2 or two or more positioning components 2. When the battery pack has two or more positioning components 2, the specific positions of the positioning components 2 on the battery pack may depend on actual requirements, for example, may be determined by an internal structural frame of the battery pack, or may be determined by a specific construction of the pre-welding positioning system.

The battery pack to be welded may be composed of at least one battery module and an associated case. Correspondingly, the product information of the battery pack to be welded may be blueprint information of the battery pack to be welded, where the blueprint information refers to position identification point (mark position) information in the battery pack to be welded, such as terminal post position information in the battery pack.

In some embodiments of the present disclosure, the preset reference point may be a vision acquisition center 1141 in the vision acquisition system 114 or may be an acquisition reference point in the pre-welding positioning system. Correspondingly, the distance deviation value may refer to offset coordinates of the mark position relative to the vision acquisition center 1141.

The distance deviation value may be a numerical value in a two-dimensional plane coordinate system, which includes: a first deviation value in an X-axis direction and a second deviation value in a Y-axis direction.

Herein, the vision acquisition system 114 is further configured to send, after determining the distance deviation value between the positioning component 2 and the preset reference point, the distance deviation value to a storage module of the controller.

In some embodiments of the present disclosure, in the pre-welding positioning system, the controller is configured to control, based on the product information of the battery pack to be welded such as the mark position in the battery pack to be welded, the three-axis mechanism 11 in the frame body 1 to move to the designated position such as a position directly above the battery pack to be welded. Therefore, the vision acquisition system 114 positioned on the three-axis mechanism 11 receives an acquisition instruction sent by the controller, in response to the three-axis mechanism 11 where it is positioned reaching the designated position, and acquires the image of the positioning component 2 (positioning hole) of the battery pack to be welded so as to obtain the detection image, and further sends the distance deviation value between the positioning component 2 and the preset reference point identified in the detection image to the controller. Furthermore, the controller can be configured to control the three-axis mechanism 11 to move once again based on the received distance deviation value so as to drive the fixing component 115 arranged thereon to move to the positioning component 2 of the battery pack to be welded, such as to the position directly above the positioning component 2 of the battery pack, so as to fix the battery pack to be welded to the frame body 1 by coupling of the fixing component 115 with the positioning component 2, thereby providing a foundation for subsequent welding of the battery pack to be welded.

As such, the vision acquisition system 114 arranged on the three-axis mechanism 11 acquires, at the designated position, the image of the positioning component 2 of the battery pack, in response to the controller controlling the three-axis mechanism 11 to reach the designated position, and obtains the distance deviation value between the positioning component 2 and the preset reference point, such that the controller controls the three-axis mechanism 11 to drive the fixing component 115 to the positioning component 2 based on the distance deviation value so as to fix the battery pack to the frame body 1 by the fixing component 115. In this way, the battery pack can be accurately positioned in the pre-welding positioning system, thereby improving the accuracy and efficiency of the battery pack in the welding process.

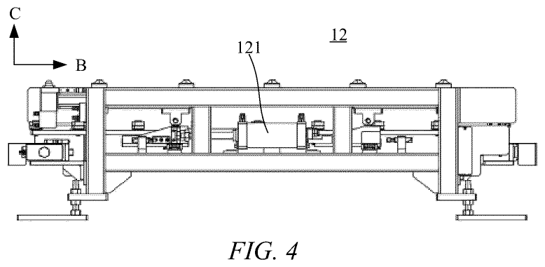

Before the welding of the battery pack, the battery pack to be welded is usually transported by a transport trolley (not shown) to a preset station, and the controller receives a positioning request sent by the transport trolley and controls a jacking mechanism to jack up the battery pack for positioning so as to implement the pre-welding positioning of the battery pack. As shown in FIG. 4, the frame body 1 is further provided with the jacking mechanism 12 on which a jacking cylinder 121 is arranged, and the jacking cylinder 121 extends to disengage the battery pack on the transport trolley from the transport trolley.

The controller is further configured to control the jacking cylinder 121 on the frame body 1 to extend to jack up the battery pack to a preset height, in response to the positioning request sent by the transport trolley; and then control the three-axis mechanism 11 to move to the designated position based on the product information.

In some embodiments of the present disclosure, the transport trolley may be an automated guided vehicle (AGV), which is generally referred to as being equipped with an electromagnetic or optic automated guided device and thus being capable of traveling along a defined guiding path for assisted logistics transport.

The battery pack to be welded is loaded on the transport trolley before the battery pack to be welded enters the corresponding preset station of the pre-welding positioning system.

In some embodiments of the present disclosure, the jacking cylinder 121 arranged on the jacking mechanism 12 is a hydraulic device for lifting the battery pack. When the jacking cylinder 121 extends, the battery pack is jacked up to the preset height.

The jacking height may be determined in advance by other control devices in the pre-welding positioning system or by the controller based on basic properties of the jacking cylinder 121.

In some embodiments of the present disclosure, the controller is configured to obtain a positioning request sent by the transport trolley when the battery pack thereon reaches the preset station, and then control the three-axis mechanism 11 to move to the designated position. The preset station may be a pre-welding station corresponding to the pre-welding positioning system. Therefore, the controller can be configured to control the jacking cylinder 121 to extend to jack up the battery pack to the preset height, in response to the received positioning request, such that the battery pack is disengaged from the transport trolley and the battery pack is jacked to a fixed position, thereby facilitating a further operation, for example, the controller controlling the three-axis mechanism 11 to move to the designated position based on the product information of the battery pack.

As such, the battery pack on the transport trolley is jacked up by the jacking mechanism 12 arranged on the frame body 1, such that the battery pack is disengaged from the transport trolley, thereby providing a foundation for subsequent pre-welding positioning of the battery pack.

In some embodiments of the present disclosure, the controller can compare the product information of the battery pack on the transport trolley to the pre-stored information to be compared of the battery pack in the pre-welding positioning system, which can reduce the probability that the battery pack entering the pre-welding positioning system does not meet the expectation.

The controller is further configured to obtain the read product information of the battery pack and the information to be compared of the battery pack, in response to the positioning request sent by the transport trolley; and
control the jacking cylinder 121 to extend in response to the product information being consistent with the information to be compared.

In some embodiments of the present disclosure, the information to be compared of the battery pack may be default product information of battery packs allowed for pre-welding positioning in the pre-welding positioning system. The controller is configured to compare the product information of the battery pack to be welded entering the pre-welding positioning system to the information to be compared.

When both the product information of the battery pack and the information to be compared of the battery pack include a plurality of pieces of terminal post position information, the pieces of terminal post position information included in the product information are compared correspondingly to the pieces of terminal post position information included in the information to be compared based on the position information so as to obtain a comparison result. If the comparison result indicates that the pieces of terminal post position information included in the product information are all consistent with the pieces of terminal post position information included in the information to be compared, it indicates that the product information is consistent with the information to be compared.

In some embodiments of the present disclosure, the controller can be configured to obtain the product information on the battery pack to be welded based on radio frequency identification (RFID), in response to the positioning request sent by the transport trolley, and control, when the product information is consistent with information to be compared issued by a manufacturing execution system (MES) where the pre-welding positioning system is located, the jacking cylinder 121 arranged on the frame body 1 to extend to complete the action of the cylinder.

It should be noted that the RFID is non-contact data communication between a reader and a tag to achieve the purpose of identifying a target.

In some embodiments of the present disclosure, the controller can be configured to control the jacking cylinder 121 on the frame body 1 to extend only when read battery information of the battery pack entering the preset station is consistent with the pre-stored information to be compared of the battery pack in the system, or stop the corresponding operation (e.g., to control the jacking cylinder 121 to extend) and send alarm information when the read battery information of the battery pack entering the preset station is inconsistent with the pre-stored information to be compared of the battery pack in the system. The alarm information may be, for example, information in a human machine interface (HMI), and/or a sound-light alarm.

As such, the controller can compare the product information of the battery pack on the transport trolley to the pre-stored information to be compared in the pre-welding positioning system, which can reduce the probability that the battery pack entering the pre-welding positioning system does not meet the expectation, thereby providing a foundation for subsequent accurate pre-welding positioning of the battery pack by means of the foolproof measures.

In some embodiments of the present disclosure, the vision acquisition system 114 is further configured to send the distance deviation value to the storage module of the controller; and the distance deviation value includes: the first deviation value in the X-axis direction and the second deviation value in the Y-axis direction in the two-dimensional plane coordinate system.

In some embodiments of the present disclosure, the distance deviation value is the numerical value in the two-dimensional plane coordinate system, which includes: the first deviation value in the X-axis direction and the second deviation value in the Y-axis direction. Numerical values corresponding to the first deviation value and the second deviation value may or may not be equal, and a unit corresponding to the first deviation value and the second deviation value may be expressed in millimeters or centimeters.

As such, the vision acquisition system 114 is configured to send the obtained distance deviation value to the storage module of the controller, so that the controller can subsequently perform data storage and security management of the distance deviation value.

In some embodiments of the present disclosure, the controller can be configured to control the X-axis movement mechanism 111, the Y-axis movement mechanism 112, and the Z-axis movement mechanism 113 on the three-axis mechanism 11 to move, respectively, such that the fixing component 115 arranged on the three-axis mechanism 11 is inserted into the positioning component 2.

The controller is further configured to control the X-axis movement mechanism 111 and the Y-axis movement mechanism 112 on the three-axis mechanism 11 to move based respectively on the first deviation value and the second deviation value, such that the fixing component 115 moves to the position directly above the positioning component 2.

The controller is further configured to control the Z-axis movement mechanism 113 on the three-axis mechanism 11 to descend to the preset height, in response to the fixing component 115 reaching the position directly above the positioning component 2, such that the fixing component 115 is inserted into the positioning component 2.

In some embodiments of the present disclosure, planar movement mechanisms on the three-axis mechanism 11, i.e., the X-axis movement mechanism 111 and the Y-axis movement mechanism 112 can be controlled to move based respectively on the first deviation value and the second deviation value, and the Z-axis movement mechanism 113 on the three-axis mechanism 11 can be controlled to move, in other words, movement in the three directions cooperate to implement the spatial positioning, such that the fixing component 115 arranged on the three-axis mechanism 11 may be automatically inserted into the positioning component 2 of the battery pack to be welded.

Following the preceding description, the controller is further configured to control the jacking cylinder 121 on the frame body 1 to extend to jack up the battery pack to the preset height, in response to the positioning request sent by the transport trolley, and correspondingly, the controller is further configured to control the Z-axis movement mechanism 113 on the three-axis mechanism 11 to descend to the preset height.

As such, the controller is further configured to control the X-axis movement mechanism 111 and the Y-axis movement mechanism 112 on the three-axis mechanism 11 to move to the position directly above the positioning component 2 and control the Z-axis movement mechanism 113 on the three-axis mechanism 11 to descend to the preset height based respectively on the first deviation value, the second deviation value, and the battery pack jacked up to the preset height, such that the fixing component 115 arranged on the three-axis mechanism 11 is automatically inserted into the positioning component 2 of the battery pack. In this way, the fixing component 115 is inserted into the positioning component 2 accurately through multi-dimensional adjustment.

In some embodiments of the present disclosure, the controller is further configured to determine a first compensated distance value corresponding to the X-axis movement mechanism 111 based on the first deviation value and determine a second compensated distance value corresponding to the Y-axis movement mechanism 112 based on the second deviation value.

The controller is further configured to control the X-axis movement mechanism 111 to move based on the first compensated distance value and control the Y-axis movement mechanism 112 to move based on the second compensated distance value, such that the fixing component 115 moves to the position directly above the positioning component 2.

In some embodiments of the present disclosure, the first compensated distance value is equal to the first deviation value, and correspondingly, the second compensated distance value is equal to the second deviation value. Alternatively, a mapping relationship exists between the first compensated distance value and the first deviation value, such that the second compensated distance value corresponding to the second deviation value may be determined based on the mapping relationship.

Herein, the controller can be further configured to simultaneously control the X-axis movement mechanism 111 to move based on the first compensated distance value and control the Y-axis movement mechanism 112 to move based on the second compensated distance value. Alternatively, the controller can be configured to first control the X-axis movement mechanism 111 to move based on the first compensated distance value and then control the Y-axis movement mechanism 112 to move based on the second compensated distance value, such that the fixing component 115 moves to the position directly above the positioning component 2.

As such, the controller is configured to control the X-axis movement mechanism 111 to move based on the first compensated distance value corresponding to the first deviation value and control the Y-axis movement mechanism 112 to move based on the second compensated distance value corresponding to the second deviation value, respectively. In this way, the fixing component 115 on the three-axis mechanism 11 can be controlled to be accurately positioned directly above the positioning component 2.

In some embodiments of the present disclosure, a lower frame body and an upper frame body (not shown) are provided on the frame body 1, the jacking mechanism 12 is arranged on the lower frame body, a truss is arranged on the upper frame body, and two three-axis mechanisms 11 are arranged on the truss. The transport trolley transports the battery pack in a preset direction into a preset station corresponding to the frame body 1, and after the battery pack is disengaged from the transport trolley, the transport trolley pulls out of the preset station in a direction opposite to the preset direction.

The two three-axis mechanisms 11 are configured to fix positioning components 2 located on two opposite corners of the battery pack.

In some embodiments of the present disclosure, the frame body 1 may be composed of the upper and lower frame bodies, and the jacking mechanism 12 (including at least the jacking cylinder 121) is arranged on the lower frame body, such that the jacking cylinder 121 in the lower frame body extends under the control of the controller to disengage the battery pack on the transport trolley from the transport trolley, thereby jacking up the battery pack to the preset height. Correspondingly, the truss is arranged on the upper frame body of the frame body 1, and the two three-axis mechanisms 11 are arranged on the truss so as to fix the positioning components 2 located on the two opposite corners of the battery pack under the control of the controller.

The truss may refer to a three-axis structure of a gantry type truss manipulator, and may include: an X-axis (including left and right beams) and a Y-axis, where the Y-axis straddles the two beams of the X-axis to form a gantry structure. The two three-axis mechanisms 11 may be arranged in parallel on the Y-axis or the X-axis of the truss. The preset direction may be a direction corresponding to the Y-axis or the X-axis of the truss.

The two three-axis mechanisms 11 may be diagonally arranged on the truss. Correspondingly, the two three-axis mechanisms 11 are configured to fix the positioning components 2 located on the two opposite corners of the battery pack. Herein, fixing components 115 arranged on the two three-axis mechanisms 11 may be respectively inserted into the positioning components 2 located on the two opposite corners of the battery pack so as to fix the battery pack to the frame body 1. Therefore, the battery pack is parallel to an associated direction of the truss and a movement direction of a welding robot in a welding process, implementing automatic and accurate positioning prior to welding.

As such, the positioning components 2 located on the two opposite corners of the battery pack are respectively fixed by the two three-axis mechanisms 11, such that the fixation between the battery pack and the frame body 1 is more stable and secure.

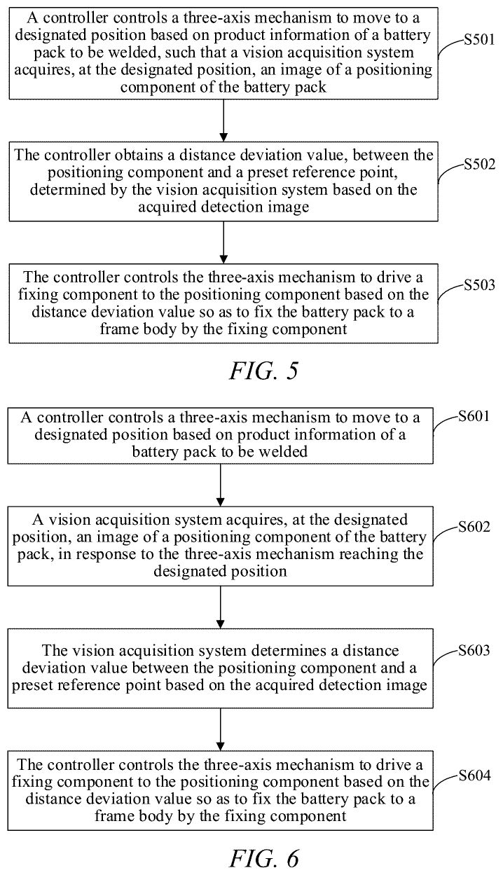

Correspondingly, an embodiment of the present disclosure further provides a pre-welding positioning method. The pre-welding positioning method may be applied to a controller of the pre-welding positioning system according to any one of the above embodiments, the pre-welding positioning system including: a frame body, a three-axis mechanism arranged on the frame body, and a vision acquisition system and a fixing component arranged on the three-axis mechanism. With reference to FIG. 5, the pre-welding positioning method includes the following steps.

In step S501, the controller controls the three-axis mechanism to move to a designated position based on product information of a battery pack to be welded, such that the vision acquisition system acquires, at the designated position, an image of a positioning component of the battery pack.

In step S502, the controller obtains a distance deviation value, between the positioning component and a preset reference point, determined by the vision acquisition system based on the acquired detection image.

In step S503, the controller controls the three-axis mechanism to drive the fixing component to the positioning component based on the distance deviation value so as to fix the battery pack to the frame body by the fixing component.

In some embodiments of the present disclosure, for a detailed description of the controller, the vision acquisition system, etc., reference may be made to the above detailed description of the pre-welding positioning system.

First, the controller controls, based on the product information of the battery pack to be welded such as a plurality of pieces of terminal post position information in the battery pack, the three-axis mechanism to move to the designated position (such as a preset image acquisition position), such that the vision acquisition system acquires, at the designated position, the image of the positioning component of the battery pack. Next, the controller obtains the distance deviation value, between the positioning component and the preset reference point, determined by the vision acquisition system based on the acquired detection image (such as a distance deviation value between the positioning component and a vision acquisition center of the vision acquisition system). Finally, the controller controls the three-axis mechanism to drive the fixing component to the positioning component based on the distance deviation value so as to fix the battery pack to the frame body by the fixing component.

For further details of the implementation, reference may be made to the detailed description of the pre-welding positioning system in the above embodiments, which will not be repeated herein.

As such, the vision acquisition system arranged on the three-axis mechanism acquires, at the designated position, the image of the positioning component of the battery pack, in response to the controller controlling the three-axis mechanism to reach the designated position, and obtains the distance deviation value between the positioning component and the preset reference point, such that the controller controls the three-axis mechanism to drive the fixing component to the positioning component based on the distance deviation value so as to fix the battery pack to the frame body by the fixing component. In this way, the battery pack can be accurately positioned in the pre-welding positioning system, thereby improving the accuracy and efficiency of the battery pack in the welding process.

In some embodiments of the present disclosure, the frame body is provided with a jacking mechanism on which a jacking cylinder is arranged, and before the controller controls the three-axis mechanism to move to the designated position based on the product information of the battery pack to be welded, the pre-welding positioning method further includes the following step.

In step A, the controller controls the jacking cylinder to extend to jack up the battery pack on a transport trolley to a preset height, in response to a positioning request sent by the transport trolley, such that the battery pack on the transport trolley is disengaged from the transport trolley.

In some embodiments of the present disclosure, the controller controls the jacking cylinder to extend in response to the positioning request sent by the transport trolley. To be specific, step A provided in the above embodiments further includes the following steps.

In step A1, the controller obtains the read product information of the battery pack and information to be compared of the battery pack, in response to the positioning request sent by the transport trolley.

In step A2, the controller controls the jacking cylinder to extend in response to the product information being consistent with the information to be compared.

In some embodiments of the present disclosure, the pre-welding positioning method may further implement the following step B.

In step B, the controller obtains the distance deviation value sent by the vision acquisition system and stores the distance deviation value to a storage module; and the distance deviation value includes: a first deviation value in an X-axis direction and a second deviation value in a Y-axis direction in a two-dimensional plane coordinate system.

Correspondingly, the distance deviation value includes: the first deviation value in the X-axis direction and the second deviation value in the Y-axis direction in the two-dimensional plane coordinate system. For controlling the three-axis mechanism to drive the fixing component to the positioning component based on the distance deviation value, the pre-welding positioning method further includes steps C1 and C2 below.

In step C1, the controller controls an X-axis movement mechanism and a Y-axis movement mechanism on the three-axis mechanism to move based respectively on the first deviation value and the second deviation value, such that the fixing component moves to a position directly above the positioning component.

In step C2, the controller controls a Z-axis movement mechanism on the three-axis mechanism to descend to the preset height, in response to the fixing component reaching the position directly above the positioning component, such that the fixing component is inserted into the positioning component.

In some embodiments of the present disclosure, step C1 above may be further implemented by the following steps.

In step C11, the controller determines a first compensated distance value corresponding to the X-axis movement mechanism based on the first deviation value and determines a second compensated distance value corresponding to the Y-axis movement mechanism based on the second deviation value.

In step C12, the controller controls the X-axis movement mechanism to move based on the first compensated distance value and controls the Y-axis movement mechanism to move based on the second compensated distance value, such that the fixing component moves to the position directly above the positioning component.

For further details of implementations of step A (including step A1 and step A2), step B, step C1 (including step C11 and step C12), step C2, and corresponding effects thereof, reference may be made to the detailed description of the pre-welding positioning system in the above embodiments, which will not be repeated herein.

Correspondingly, an embodiment of the present disclosure further provides a pre-welding positioning method, and the pre-welding positioning method may be applied to the pre-welding positioning system according to any one of the above embodiments, the pre-welding positioning system including: a frame body, a controller, a three-axis mechanism arranged on the frame body, and a vision acquisition system and a fixing component arranged on the three-axis mechanism. As shown in FIG. 6, the method includes the following steps.

In step S601, the controller controls the three-axis mechanism to move to a designated position based on product information of a battery pack to be welded.

In step S602, the vision acquisition system acquires, at the designated position, an image of a positioning component of the battery pack, in response to the three-axis mechanism reaching the designated position.

In step S603, the vision acquisition system determines a distance deviation value between the positioning component and a preset reference point based on the acquired detection image.

In step S604, the controller controls the three-axis mechanism to drive the fixing component to the positioning component based on the distance deviation value so as to fix the battery pack to the frame body by the fixing component.

In some embodiments of the present disclosure, the pre-welding positioning method may be applied to the pre-welding positioning system according to any one of the above embodiments. For a detailed description of the controller, the vision acquisition system, etc., in the pre-welding positioning system, reference may be made to the above detailed description of the pre-welding positioning system.

For further details of the implementation, reference may be made to the detailed description of the pre-welding positioning system in the above embodiments, which will not be repeated herein.

Finally, it should be noted that the foregoing embodiments are merely used for illustrating rather than limiting the technical solutions of the present disclosure. Although the present disclosure has been illustrated in detail with reference to the foregoing embodiments, it should be understood by those of ordinary skill in the art that the technical solutions described in the foregoing embodiments may still be modified, or some or all of the technical features thereof may be equivalently substituted; and such modifications or substitutions do not make the essence of the corresponding technical solutions depart from the scope of the technical solutions of the embodiments of the present disclosure, and should fall within the scope of the description of the present disclosure. In particular, the technical features mentioned in the embodiments can be combined in any manner, provided that there is no structural conflict. The present disclosure is not limited to the particular embodiments disclosed herein, but includes all the technical solutions that fall within the scope of the description.

### INDUSTRIAL APPLICABILITY

The embodiments of the present disclosure enable a battery pack to be accurately positioned in a pre-welding positioning system, thereby improving the accuracy and efficiency of the battery pack in the welding process.

What is claimed is:

1. A pre-welding positioning system, comprising: a frame body, a controller, a three-axis mechanism arranged on the frame body, and a vision acquisition system and a fixing component arranged on the three-axis mechanism, wherein:
the controller is configured to control the three-axis mechanism to move to a designated position based on product information of a battery pack to be welded;
the vision acquisition system is configured to acquire, at the designated position, an image of a positioning component of the battery pack, in response to the three-axis mechanism reaching the designated position, and determine a distance deviation value between the positioning component and a preset reference point based on the acquired detection image; and
the controller is further configured to control the three-axis mechanism to drive the fixing component to the positioning component based on the distance deviation value so as to fix the battery pack to the frame body by the fixing component.

2. The pre-welding positioning system according to claim 1, wherein:
the frame body is further provided with a jacking mechanism on which a jacking cylinder is arranged, and the jacking cylinder extends to disengage the battery pack on a transport trolley from the transport trolley; and
the controller is further configured to control the jacking cylinder to extend to jack up the battery pack to a preset height, in response to a positioning request sent by the transport trolley; and then control the three-axis mechanism to move to the designated position based on the product information.

3. The pre-welding positioning system according to claim 2, wherein the controller is further configured to:
obtain the read product information of the battery pack and information to be compared of the battery pack, in response to the positioning request sent by the transport trolley; and
control the jacking cylinder to extend in response to the product information being consistent with the information to be compared.

4. The pre-welding positioning system according to claim 1, wherein:
the vision acquisition system is further configured to send the distance deviation value to a storage module of the controller; and
the distance deviation value comprises: a first deviation value in an X-axis direction and a second deviation value in a Y-axis direction in a two-dimensional plane coordinate system.

5. The pre-welding positioning system according to claim 4, wherein:
the controller is further configured to control an X-axis movement mechanism and a Y-axis movement mechanism on the three-axis mechanism to move based respectively on the first deviation value and the second deviation value, such that the fixing component moves to a position directly above the positioning component; and
the controller is further configured to control a Z-axis movement mechanism on the three-axis mechanism to descend to the preset height, in response to the fixing component reaching the position directly above the positioning component, such that the fixing component is inserted into the positioning component.

6. The pre-welding positioning system according to claim 5, wherein the controller is further configured to:
determine a first compensated distance value corresponding to the X-axis movement mechanism based on the first deviation value and determine a second compensated distance value corresponding to the Y-axis movement mechanism based on the second deviation value; and
control the X-axis movement mechanism to move based on the first compensated distance value and control the Y-axis movement mechanism to move based on the second compensated distance value, such that the fixing component moves to the position directly above the positioning component.

7. The pre-welding positioning system according to claim 1, wherein:
a lower frame body and an upper frame body are provided on the frame body, the jacking mechanism is arranged on the lower frame body, a truss is arranged on the upper frame body, and two three-axis mechanisms are arranged on the truss;
the transport trolley transports the battery pack in a preset direction into a preset station corresponding to the frame body, and after the battery pack is disengaged from the transport trolley, the transport trolley pulls out of the preset station in a direction opposite to the preset direction; and
the two three-axis mechanisms are configured to fix positioning components located on two opposite corners of the battery pack.

8. A pre-welding positioning method, applied to a controller of a pre-welding positioning system, the pre-welding positioning system comprising: a frame body, a three-axis mechanism arranged on the frame body, and a vision acquisition system and a fixing component arranged on the three-axis mechanism, and comprising:
controlling the three-axis mechanism to move to a designated position based on product information of a battery pack to be welded, such that the vision acquisition system acquires, at the designated position, an image of a positioning component of the battery pack;
obtaining a distance deviation value, between the positioning component and a preset reference point, determined by the vision acquisition system based on the acquired detection image; and
controlling the three-axis mechanism to drive the fixing component to the positioning component based on the distance deviation value so as to fix the battery pack to the frame body by the fixing component.

9. The pre-welding positioning method according to claim 8,
wherein the frame body is provided with a jacking mechanism on which a jacking cylinder is arranged;
the pre-welding positioning method further comprising, before the controller controls the three-axis mechanism to move to the designated position based on the product information of the battery pack to be welded:
the controller controlling the jacking cylinder to extend to jack up the battery pack on a transport trolley to a preset height, in response to a positioning request sent by the transport trolley, such that the battery pack on the transport trolley is disengaged from the transport trolley.

10. The pre-welding positioning method according to claim 9, wherein the controller controlling the jacking cylinder to extend in response to the positioning request sent by the transport trolley comprises:
the controller obtaining the read product information of the battery pack and information to be compared of the battery pack, in response to the positioning request sent by the transport trolley; and
the controller controlling the jacking cylinder to extend in response to the product information being consistent with the information to be compared.

11. The pre-welding positioning method according to claim 8, wherein:
the distance deviation value comprises: a first deviation value in an X-axis direction and a second deviation value in a Y-axis direction in a two-dimensional plane coordinate system; and
controlling the three-axis mechanism to drive the fixing component to the positioning component based on the distance deviation value comprises:
the controller controlling an X-axis movement mechanism and a Y-axis movement mechanism on the three-axis mechanism to move based respectively on the first deviation value and the second deviation value, such that the fixing component moves to a position directly above the positioning component; and
the controller controlling a Z-axis movement mechanism on the three-axis mechanism to descend to the preset height, in response to the fixing component reaching the position directly above the positioning component, such that the fixing component is inserted into the positioning component.

12. The pre-welding positioning method according to claim 11, wherein the controller controlling the X-axis movement mechanism and the Y-axis movement mechanism on the three-axis mechanism to move based respectively on the first deviation value and the second deviation value, such that the fixing component moves to the position directly above the positioning component comprises:
the controller determining a first compensated distance value corresponding to the X-axis movement mechanism based on the first deviation value and determining a second compensated distance value corresponding to the Y-axis movement mechanism based on the second deviation value; and
the controller controlling the X-axis movement mechanism to move based on the first compensated distance value and controlling the Y-axis movement mechanism to move based on the second compensated distance value, such that the fixing component moves to the position directly above the positioning component.

13. A pre-welding positioning method, applied to a pre-welding positioning system, the pre-welding positioning system comprising: a frame body, a controller, a three-axis mechanism arranged on the frame body, and a vision acquisition system and a fixing component arranged on the three-axis mechanism, and the method comprising:
the controller controlling the three-axis mechanism to move to a designated position based on product information of a battery pack to be welded;
the vision acquisition system acquiring, at the designated position, an image of a positioning component of the battery pack, in response to the three-axis mechanism reaching the designated position;
the vision acquisition system determining a distance deviation value between the positioning component and a preset reference point based on the acquired detection image; and
the controller controlling the three-axis mechanism to drive the fixing component to the positioning component based on the distance deviation value so as to fix the battery pack to the frame body by the fixing component.
